(19) United States
(12) Patent Application Publication
(10) Pub. No.: US 2011/0296968 A1
(43) Pub. Date: Dec. 8, 2011

(54) FEEDBACK MECHANISM FOR ADJUSTABLE MITER FENCE

(75) Inventor: Robert Doumani, Hoffman Estates, IL (US)

(73) Assignees: Robert Bosch GmbH, Stuttgart (DE); Robert Bosch Tool Corporation, Broadview, IL (US)

(21) Appl. No.: 12/792,525

(22) Filed: Jun. 2, 2010

(51) Int. Cl. B27B 27/08

(52) U.S. Cl. 83/468.2

(57) ABSTRACT

A table saw comprises a non magnetic table top surface, a rotatable cutting blade extending through a longitudinal opening of the table top surface, a fence plate for supporting a work piece, the fence plate being adjustable relative to a path that intersects the longitudinal opening, and a feedback mechanism for indicating a position of the fence plate relative to the longitudinal opening. The feedback mechanism comprises a magnetic material or at least one magnet disposed on or in the table top surface adjacent to the longitudinal opening and extending parallel to the cutting blade, and the magnetic material or at least one magnet is disposed in the path of the fence plate. The fence plate further comprises a magnetic material or at least one magnet at or near an end thereof to interact with the other of the magnetic material or at least one magnet on or in the table top surface when the fence plate is selectively positioned relative to the path towards the longitudinal opening.

### BACKGROUND OF THE INVENTION

A field of the invention is power tools. More particular embodiments of the present invention relate to power tools that use a fence for guiding work pieces during operation of the tool.

It has long been known that table saws as well as other saws and power tools can use fences for guiding work pieces during a cutting or similar operation. The fences are typically adjustable to accommodate variously dimensioned work pieces or to vary the amount of material that is being cut. Such fences are especially useful for cutting boards or sheets of material as they are being fed to the saw blade of the table saw. Of course, fences are used for similar control with regard to many kinds of power tools, such as routers and shapers, miter saws, radial arm saws, and the like.

For example, FIG. 1 shows a table saw 10 that performs the functions of both a table saw for ripping and a miter saw for cross cutting. As shown in FIG. 1, the table saw 10 generally includes a support, such as a frame 12 with extendable table legs 13, which supports a generally flat upper table top surface 14 (such as a table top). A rotatable cutting blade 16 is disposed within a longitudinal opening 18 in the table top surface 14, providing a slot for blade travel clearance, and the cutting blade is selectively movable within the longitudinal opening and thus along a longitudinal direction. For example, movement of the cutting blade 16 may be performed in miter saw mode by pulling a handle 20 of a pull stick 22 coupled to the cutting blade.

The table saw 10 includes a miter fence, indicated generally at 24, that is supported by the table top surface 14 and mounted to one of the (e.g., four) edges 25 of the table. This miter fence 24 supports a work piece 26 in both a table saw mode where a fence plate 28 is set parallel to the blade 16 and a miter saw mode where the fence plate 28 is set at a specific miter angle relative to the blade. The miter fence plate 28, against which the work piece 26 is placed during cutting for guidance, is slidably mounted to an angle plate 30, which is rotatably coupled to an extension arm 34 for adjusting a miter angle. The extension arm 34 is slidably coupled to a table clamp 36, which is adjustably mounted to one of the four table edges 25. Clamps (e.g., with suitable clamp knobs) are provided for locking the table clamp 36, the extension 34, the angle plate 30, and/or the miter fence plate 28 after adjustment.

Thus, the miter fence plate is adjustable along various directions, which include a generally lateral direction or other possible directions at an angle to the lateral direction due to adjustment of the extension arm 34 or the rotation of the angle plate 30. For adjusting a cutting angle, the miter fence plate 28 also is angularly adjustable due to the rotation of the angle plate 30. In this way, the miter fence plate 28 is adjustable so that both the miter angles and the width of cut are changeable as needed to complete the cut. The miter fence plate 28 can be moved, rotated and/or otherwise adjusted to a desired position and clamped. In operation during table saw mode, the cutting blade 16 is fixed, and the cutting material is pushed. In operation during miter saw mode, the work piece 26 is fixed, and the cutting blade 16 is pulled.

### SUMMARY OF THE INVENTION

Embodiments of the present invention provide, among other things, a table saw, comprising a non magnetic table top surface, a rotatable cutting blade extending through a longitudinal opening of the table top surface, a fence plate for supporting a work piece, the fence plate being adjustable relative to a path that intersects the longitudinal opening, and a feedback mechanism for indicating a position of the fence plate relative to the longitudinal opening. The feedback mechanism comprises a magnetic material disposed on or in the non magnetic table top surface and adjacent to the longitudinal opening, and the magnetic material is disposed parallel to the blade and in the path of the fence plate. The fence plate further comprises a magnet at or near an end thereof to interact with the magnetic material when the fence plate is selectively positioned relative to the path towards the longitudinal opening. Alternatively, the magnetic material may be disposed in the fence plate, and the at least one magnet may be disposed on or in the non-magnetic table top surface.

### BRIEF DESCRIPTION OF THE DRAWINGS

FIG. 1 is a perspective front view of a table saw including an adjustable miter fence and a cutting blade;

FIG. 2 is a perspective front view of a feedback mechanism for an adjustable miter fence, according to an embodiment of the present invention;

FIG. 3 is an exploded perspective view of an example miter fence plate, showing insertion of magnets;

FIGS. 4A-4B are a front perspective view of an upper non magnetic table top surface for a table saw with an example magnetic material, and the upper table top surface with a magnetic material mounted thereto, respectively;

FIGS. 5A-5B are front perspective views of a table saw according to an example embodiment of the present invention before a cutting blade is moved and after the cutting blade is moved along a longitudinal opening, respectively; and

FIGS. 6A-6B are a front perspective view and an enlarged front partial view, respectively, of a table saw according to an embodiment of the present invention, showing the miter fence plate rotated to an oblique angle with respect to the longitudinal opening.

### DETAILED DESCRIPTION

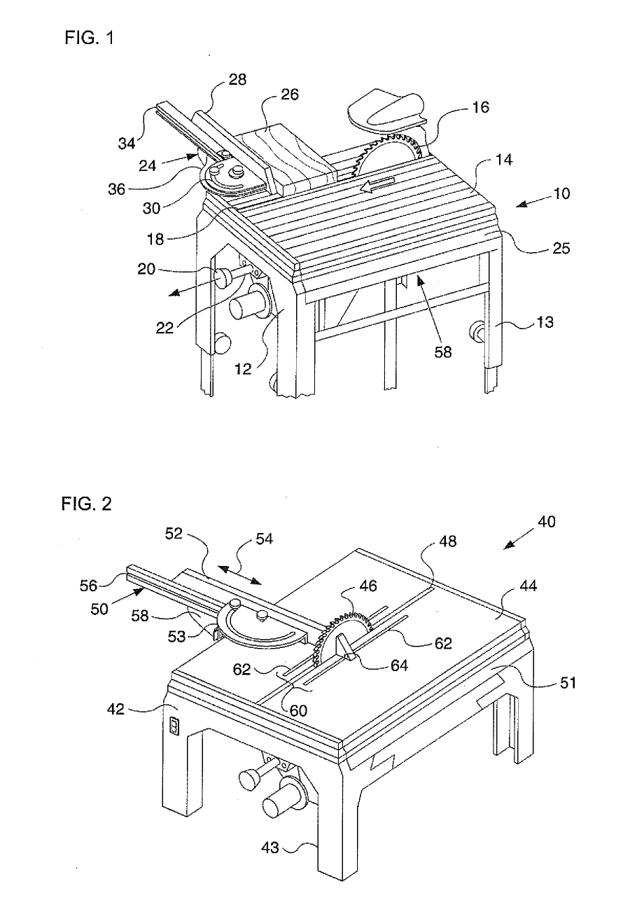

In a table saw of the type shown in FIG. 1, the operator solely determines the position or location of the miter fence plate relative to the blade. For example, in miter saw mode, the operator visually locates the miter fence plate so that it remains away from the blade travel path. This blade travel path may be, as shown in the example of FIG. 1, a longitudinal path along the table saw table top surface that can intersect the path of travel of the miter fence plate (or vice versa). There are no provisions for positive stops or indicators to inform the operator whether the miter fence plate is in the path of the blade or not. As a result, the miter fence plate can be clamped in front of the blade travel path, in which case the cutting blade when pulled may cut through the cutting material and continue to cut or otherwise damage the miter fence plate.

Broadly stated, the present invention is directed to, among other things, a feedback mechanism for an adjustable miter fence for a table saw. The table saw includes a support, a non magnetic table top surface disposed over the support, a longitudinal opening extending along the table top surface, and a rotatable cutting blade extending through the longitudinal opening and selectively movable along the longitudinal opening. A miter fence plate for supporting a work piece is adjustable relative to a path that intersects the longitudinal opening. The feedback mechanism comprises a magnetic material disposed on or near the non magnetic table top surface in a position that is parallel to the blade and adjacent to the longitudinal opening and in the path of the fence plate. At least one magnet is disposed on or in the miter fence plate to interact with the magnetic material when the fence plate is selectively positioned relative to the path towards the longitudinal opening.

Alternatively, the feedback mechanism comprises at least one magnet disposed on or near the non magnetic table top in a position that is adjacent to the longitudinal opening and extending parallel to the blade, and a magnetic material is disposed on or in the miter fence plate. In the examples shown and described herein, it is to be understood that where a magnetic material is disclosed, a magnet may be used, and vice versa.

Thus, as the miter fence plate is selectively positioned relative to the path towards the longitudinal opening, the magnet (or magnetic material) on or in the miter fence plate magnetically interacting with the magnetic material (or magnet) provides feedback. Feedback as used herein can include a transmission of force (including forces or torque) to a user providing evaluative or corrective information during movement of the miter fence plate, where the force is due to magnetic interaction between the at least one magnet and the magnetic material. This force may be provided by an attractive force between the at least one magnet and the magnetic material (and vice versa), or a repulsive force between the at least one magnet and the magnetic material, for instance depending on the poles of the at least one magnet with respect to the magnetic material (e.g., north-north repulsive or north-south attraction). The attractive or repulsive force between the at least one magnet and the magnetic material is transmitted to a user as a force felt by the user when manipulating the miter fence plate. For example, the force may be transmitted to the user via the miter fence plate, as it is adjusted by the user.

The amount of feedback provided will depend on the strength of the magnetic interaction between the at least one magnet and the magnetic material. For example, the strength of the magnets used can determine the amount of feedback. However, it is preferred that the feedback be sufficient to allow a user manipulating the miter fence plate to easily feel a force transmitted to the user that is generated by the magnetic interaction between the at least one magnet and the magnetic material as the miter fence plate approaches or reaches the magnetic material. For example, such feedback can be sensed by an operator adjusting the miter fence plate to notify the operator that the miter fence plate is over or near the longitudinal opening of the blade.

In alternative or additional examples of feedback, after the magnet detects the magnetic strip on the non magnetic table top (or vice versa), it can send an electrical, electronic, or a mechanical signal to alert the operator. Nonlimiting examples include the magnets sending a signal to turn on a caution light or a caution alarm.

Preferably, the magnetic material is disposed on laterally opposed sides of the longitudinal opening. In this way, the miter fence assembly can be clamped on either side of the table and therefore feedback can be provided from the preferably substantially identical magnetic material on both sides.

In a preferred embodiment, the magnetic material comprises a plate, such as a plate of ferromagnetic metal or plastic-like magnetic material, disposed on or within the (non-magnetic) table top surface that extends along a direction substantially parallel to the blade (e.g., substantially parallel to the longitudinal opening). In this way, even if the miter fence is angularly adjusted with respect to the table top surface, and/or the miter fence plate is movable relative to a path that is at an oblique angle to the longitudinal opening, the path of the miter fence plate can still intersect the magnetic material, and the feedback mechanism can still provide feedback when the miter fence plate is selectively positioned relative to this path towards the longitudinal opening.

Using the example feedback mechanism, feedback is provided to an operator so that the miter fence plate can be properly adjusted with respect to the cutting blade. In other words, the operator is provided with feedback so that, if desired, the miter fence plate can be adjusted to a position that clears the cutting blade travel path.

Turning now to the drawings, FIG. 2 shows a table saw 40 of a push-pull type having a feedback mechanism according to an example embodiment of the present invention. As with the table saw 10, the table saw 40 includes a support, such as a frame 42 having legs 43 (which may or may not be adjustable), a table top surface 44 such as a table top (e.g., mounted to one or more edges of the frame 42), and a cutting blade 46 disposed within a longitudinal opening 48 and movable along the longitudinal opening. The longitudinal opening 48 preferably, but not necessarily, extends along part of the length of the table top surface 44, and is collinear with the length of the cutting blade 46. For supporting a workpiece, the table saw 40 includes a miter fence, indicated generally at 50, that is mounted to one of the edges 51 of the table top surface 44. This miter fence 50 is adjustable with respect to the table top surface. The miter fence 50 includes a miter fence plate 52 that is slidably, adjustably coupled to an angle plate 53 for rotating the miter fence plate. The miter fence plate 52 is adjustable, e.g., angularly and longitudinally adjustable, relative to an adjustment path (or path) 54 that intersects the longitudinal opening 48.

The example path 54 shown in FIG. 2 is generally a lateral direction perpendicular to the longitudinal opening 48. However, the path 54 is not limited to the direction shown in FIG. 2, as rotation of the miter fence 50 realigns the path to a direction that is oblique to the longitudinal opening 48. Additional adjustment is provided by an extension arm 56 to which the angle plate 53 is slidably mounted. This extension arm 56 is in turn slidably coupled to a table clamp 58, which is mounted to one of the edges 51 to retain a position of the miter fence 50. One or more clamps for the table clamp 58, the extension arm 56, the angle plate 53, and/or the miter fence plate 52 can be used to retain a position of the miter fence plate after rotational and/or linear adjustment.

To provide feedback during adjustment of the miter fence plate 52, a feedback mechanism, indicated generally at 60, is provided, including components in or on the table top surface 48 and in or on the miter fence plate. In an example embodiment, the feedback mechanism 60 includes at least one, and preferably a laterally opposed pair, of pieces of a magnetic material 62, as well as at least one magnet 64 disposed in the miter fence plate 52. Each piece (e.g., strip) of the magnetic material 62 is disposed at a location adjacent to the longitudinal opening 48, parallel to the cutting blade 46 (i.e., parallel to the length of the cutting blade) and in the path 54 of the adjustable miter fence plate 52. The magnetic material 62 interacts with the one or more magnets 64 disposed in or on the miter fence plate 52 to provide feedback when the miter fence plate 52 is selectively positioned (e.g., by a user) relative to the path 54 towards the longitudinal opening 48. The magnetic material 62 may include any suitable material, non limiting examples of which include ferromagnetic metal and/or plastic-like magnetic material. By placing the magnetic material 62 on either side of the longitudinal opening, the magnetic material can be used to provide feedback even when the miter fence plate 52 is moved to a laterally opposed side of the table 40.

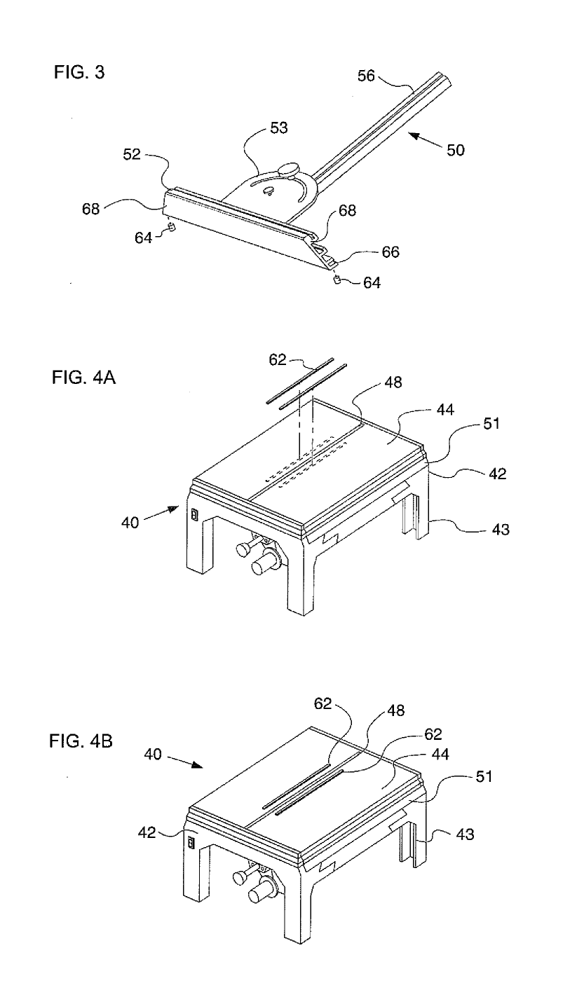

FIG. 3 shows an example embodiment for the miter fence plate 52 having a feedback mechanism. The magnets 64 may be disposed either in or on the miter fence plate 52, though it is preferred that the magnets do not obstruct the work piece 26 that is placed against the miter fence plate during use. For example, generally cylindrical magnets 64 (though other shapes are possible) may be assembled respectively within openings 66 at or near both ends 68 of the miter fence plate 52. By placing the magnets 64 at the ends 68 of the miter fence plate, the magnetic material interacts (e.g., magnetically interacts) with the magnets 64 when the end 68 closest to the longitudinal opening 48 is near the longitudinal opening. This provides early feedback when adjusting the miter fence plate 52.

Referring to FIGS. 2 and 4A-4B, the example magnetic material 62 is embodied in a pair of thin metal strips or plates disposed on laterally opposing sides of the longitudinal opening 48, parallel to a length of the cutting blade 46. In a nonlimiting example embodiment shown in FIGS. 4A-4B, the metal plates 62 are mounted to the table top surface 44 at both laterally opposed sides. Nonlimiting example mounting methods include fastening or adhering to the table top surface 44, forming or fixing the pieces within an opening or openings of the table top surface 44, etc. It is preferred that the magnetic material 62 be disposed on or in the table top surface 44 in such a way as to avoid obstructing the adjustment path 54 of the miter fence plate 52. The table top surface 44 preferably is made from a non-magnetic material to avoid interfering with the feedback mechanism 60. In a nonlimiting example embodiment, the table top surface is made of aluminum, and the metal plates 62 are made from steel. Other materials are possible for the table top surface and the metal plates, such as but not limited to, stainless steel, or any other suitable non magnetic material. Instead of plates or strips, cylindrical pieces may be used. Further, the magnetic material 62 may be segmented, instead of being embodied in a single, continuous piece. As another nonlimiting example, instead of metal plates, the magnetic material may be embodied in magnetic particles that are embedded into a portion of the table top surface 44.

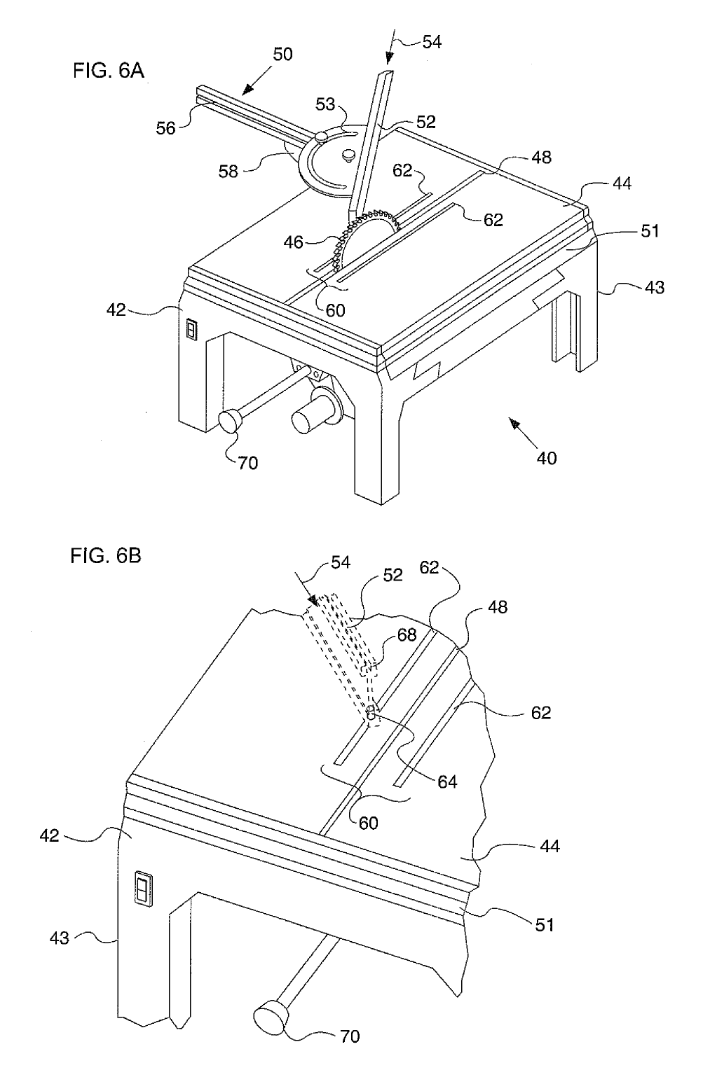

The magnetic material, such as the ferromagnetic metal plates 62, preferably extends along a general direction that is parallel to the cutting blade 46, and thus parallel to the collinear longitudinal opening 48. This allows the magnetic material 62 to be disposed along the adjustment path 54 even if the miter fence plate 52 is rotated. For example, FIG. 6A shows the miter fence plate 52 rotated so that the example adjustment path 54 is at an angle that is oblique to the direction of the longitudinal opening 48. As more clearly shown in FIG. 6B, even at this oblique angle, one or both of the metal plates 62 are in the adjustment path 54, so that the miter fence plate 52, and particularly the magnet 64 embedded at the end 68, passes over the metal plate 62 as it approaches and crosses the longitudinal opening 48. Thus, example configurations, placements, and orientation for the magnetic material 62 allow feedback for various miter angle settings.

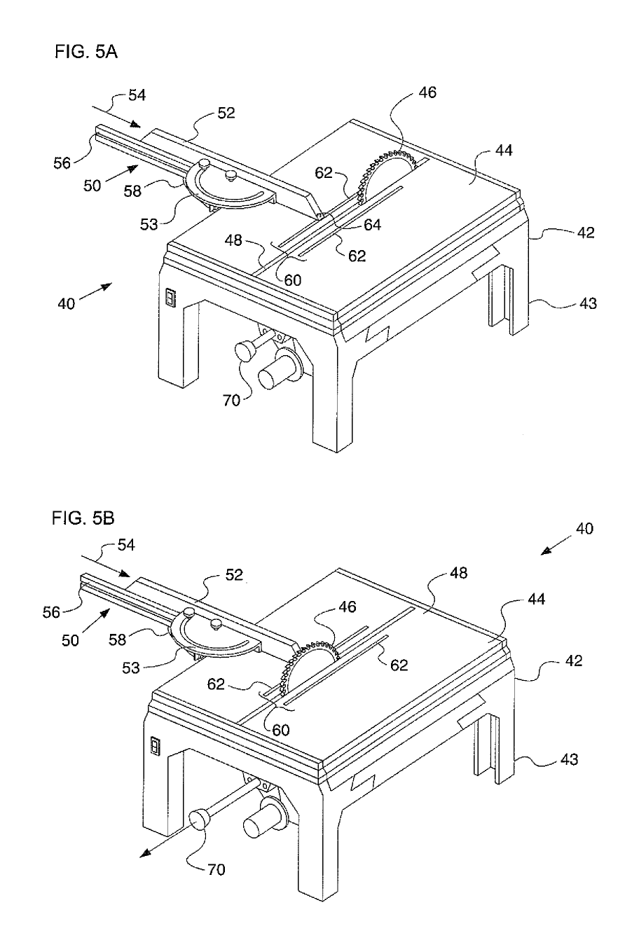

FIGS. 5A-5B show an example operation of the feedback mechanism 60 in miter saw mode, though an artisan will appreciate how a similar operation can be performed in table saw mode. As shown in FIG. 5A, prior to pulling a pull stick 70 to move the cutting blade 46, an operator can adjust the miter fence plate 52 both rotationally and linearly. As the miter fence plate 52 moves to a desired position for supporting the work piece 26, such as along the adjustment path 54, the magnet 64 within or on the end 68 of the miter fence plate 52 passes over the magnetic material 62 disposed between the miter fence plate 52 and the longitudinal opening, and the magnet interacts with the magnetic material, providing feedback indicating that the miter fence plate at this point is short of the longitudinal opening 48 (and thus the travel path of the cutting blade 46). Thus, the operator can use this feedback to stop moving the miter fence plate 52 and allowing the cutting blade 46 to clear the miter fence plate when the pull stick 70 is pulled, as shown in FIG. 5B.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

What is claimed is:

1. A table saw, comprising a table top surface, a rotatable cutting blade extending through a longitudinal opening of the table top surface, a fence plate for supporting a work piece, the fence plate being adjustable relative to a path that intersects said longitudinal opening, and a feedback mechanism for indicating a position of said fence plate relative to said longitudinal opening, said feedback mechanism comprising:
a magnetic material disposed on or in said table top surface and adjacent to said longitudinal opening, said magnetic material being disposed in the path of said fence plate; and
said fence plate further comprising at least one magnet at or near an end thereof to interact with said magnetic material when said fence plate is selectively positioned relative to said path towards said longitudinal opening.

2. A table saw as defined in claim 1 wherein said magnetic material comprises at least one plate of magnetic material disposed adjacent to said longitudinal opening and extending along a direction substantially parallel to the cutting blade.

3. A table saw as defined in claim 1 wherein said magnetic material comprises a pair of plates of magnetic material disposed at respective lateral sides of said longitudinal opening, each of said pair of plates extending along a direction substantially parallel to the cutting blade.

4. A table saw as defined in claim 1 wherein said pair of plates comprises a pair of steel plates fastened to said table top surface.

5. A table saw as defined in claim 1 wherein said magnet is embedded within the end of said miter fence plate.

6. A table saw as defined in claim 1 wherein said magnet comprises a pair of magnets embedded within opposing ends of said miter fence plate, respectively.

7. A table saw as defined in claim 1 wherein said fence plate is rotatable with respect to said table top surface.

8. A table saw as defined in claim 1 wherein said magnetic material comprises at least one plate of magnetic material disposed adjacent to said longitudinal opening and extending along a direction substantially parallel to the cutting blade;
wherein said magnetic material is disposed in said path of said fence plate when said fence plate is disposed at a plurality of angles.

9. A table saw as defined in claim 1 wherein the table saw can perform in both a miter saw mode and a table saw mode.

10. An adjustable support for use with a table saw, said table saw comprising a table top surface and a rotatable cutting blade extending through a longitudinal opening of the table top surface, said support comprising:
a fence plate for supporting a work piece, said fence plate being adjustable relative to a path that intersects said longitudinal opening;
a feedback mechanism for indicating a position of said fence plate relative to said longitudinal opening, said feedback mechanism comprising a magnetic material disposed in or on said table top surface and adjacent to said longitudinal opening, said magnetic material being disposed in the path of said fence plate; and
said fence plate further comprising a magnet at or near an end thereof to interact with said magnetic material when said fence plate is selectively positioned relative to said path towards said longitudinal opening.

11. A support as defined in claim 10 wherein said magnetic material comprises at least one plate of magnetic material disposed adjacent to said longitudinal opening and extending along a direction substantially parallel to the cutting blade.

12. A support as defined in claim 10 wherein said magnetic material comprises a pair of plates of magnetic material disposed at respective lateral sides of said longitudinal opening, each of said pair of plates extending along a direction substantially parallel to the cutting blade.

13. A support as defined in claim 10 wherein said magnet is embedded within the end of said miter fence plate.

14. A support as defined in claim 10 wherein said magnet comprises a pair of magnets embedded within opposing ends of said miter fence plate, respectively.

15. A support as defined in claim 10 wherein said magnetic material comprises at least one plate of magnetic material disposed adjacent to said longitudinal opening and extending along a direction substantially parallel to the cutting blade;
wherein said magnetic material is disposed in said path of said fence plate when said fence plate is disposed at a plurality of angles.

16. A table saw, comprising:
a support;
a table top surface disposed over said support;
a rotatable cutting blade extending through a longitudinal opening of the table top surface;
a fence plate for supporting a work piece, the fence plate being adjustable relative to a path that intersects said longitudinal opening; and
means for providing a magnetic interaction between a portion of said fence plate and a portion of said table top surface.

17. A table saw as defined in claim 16 wherein said means for providing comprises:
first means for magnetically interacting disposed in or on a portion of said table top surface and adjacent to said longitudinal opening, said first means for magnetically interacting being disposed in the path of the fence plate; and
second means for magnetically interacting disposed within said fence plate at or near at least one end thereof to magnetically interact with said first means for magnetically interacting when said fence plate moves along said path towards said longitudinal opening.

18. A table saw as defined in claim 17 wherein at least one of said first means for magnetically interacting and said second means for magnetically interacting comprises a magnet.

19. A table saw as defined in claim 18, and further comprising:
means for transmitting the provided magnetic interaction to a user.

20. A table saw, comprising a table top surface, a rotatable cutting blade extending through a longitudinal opening of the table top surface, a fence plate for supporting a work piece, the fence plate being adjustable relative to a path that intersects said longitudinal opening, and a feedback mechanism for indicating a position of said fence plate relative to said longitudinal opening, said feedback mechanism comprising:
at least one magnet disposed on or in said table top surface and adjacent to said longitudinal opening, said at least one magnet being disposed in the path of said fence plate; and
said fence plate further comprising a magnetic material at or near an end thereof to interact with said at least one magnet when said fence plate is selectively positioned relative to said path towards said longitudinal opening.

21. A table saw as defined in claim 20 wherein said at least one magnet comprises at least one plate disposed adjacent to said longitudinal opening and extending along a direction substantially parallel to the cutting blade.

22. A table saw as defined in claim 20 wherein said magnetic material is embedded within the end of said miter fence plate

23. An adjustable support for use with a table saw, said table saw comprising a table top surface and a rotatable cutting blade extending through a longitudinal opening of the table top surface, said support comprising:
a fence plate for supporting a work piece, said fence plate being adjustable relative to a path that intersects said longitudinal opening;
a feedback mechanism for indicating a position of said fence plate relative to said longitudinal opening, said feedback mechanism comprising a magnetic material disposed in or on said table top surface and adjacent to said longitudinal opening, said magnetic material being disposed in the path of said fence plate; and
said fence plate further comprising a magnet at or near an end thereof to interact with said magnetic material when said fence plate is selectively positioned relative to said path towards said longitudinal opening.
